(19) United States
(12) Patent Application Publication
(10) Pub. No.: US 2017/0183869 A1
(43) Pub. Date: Jun. 29, 2017

(54) LIGHTWEIGHT CONSTRUCTION ELEMENT, MANUFACTURING METHOD THEREFOR, USE OF SAME, AND LIGHTWEIGHT PANEL AND INSULATING MATERIAL

(71) Applicant: Bionic Alpha AG, Wil (CH)

(72) Inventor: Johann BERGER, Wil (CH)

(73) Assignee: Bionic Alpha AG, Wil (CH)

(21) Appl. No.: 15/301,685

(22) PCT Filed: Apr. 2, 2015
(86) PCT No.: PCT/EP2015/057277

§ 371 Date: Oct. 3, 2016

(30) Foreign Application Priority Data
Apr. 11, 2014 (CH) 00566/14

(51) Int. Cl. E04C 2/24; B32B 7/00; B32B 3/18; B32B 5/16; B32B 37/12; B32B 21/02; B32B 21/12; B32B 21/13; B32B 37/00; B32B 3/30; B32B 7/12

(52) U.S. Cl. CPC E04C 2/243; B32B 3/30; B32B 7/005; B32B 3/18; B32B 5/16; B32B 7/12; B32B 21/02; B32B 21/12; B32B 21/13; B32B 37/187; B32B 37/12; B32B 2264/067; B32B 2260/025; B32B 2260/046; B32B 2305/30; B32B 2317/16; B32B 2331/04; B32B 2419/00

(57) ABSTRACT

A lightweight construction element (1) comprises at least one lightweight panel (2) and a layer of insulating material (4) associated with the lightweight panel (2), wherein the at least one lightweight panel (2) comprises boards (6), which, on at least one of the main surfaces (8) thereof, have a group of grooves (9) running parallel and which boards (6) are arranged in at least one layer (5) and are connected to one another via adhesive bonds. The layer of insulating material (4) comprises wood chips (19), which are removed from starting boards during the manufacture of boards (6) for the lightweight panels (2). These lightweight construction elements have good load and thermal insulation properties. The material used originates from one source and achieves a large overall volume after processing.

The invention relates to a lightweight construction element according to the preamble of claim 1, to a method for manufacturing a lightweight construction element according to the preamble of claim 7, to a lightweight panel according to the preamble of claim 11, to the use of these lightweight construction elements and/or panels for creating a building structure according to the preamble of claim 15, and to insulating material according to the preamble of claim 16.

The invention at hand lies in the field of wood-based building material, which comprises at least one layer in the form of a panel of wood and/or a layer of insulating material.

Lightweight panels of wood are known, which are constructed of one layer, but preferably of at least two layers, which adjoin one another in a flat manner, comprising boards, which are laterally bound to one another, wherein at least the boards of one layer have cavities, in particular grooves, in at least one main surface.

Examples for the manufacture of grooved boards and lightweight panels constructed therefrom are known from patent documents AT 507 231 B1, AT 505 855 B1, AT 505 486 B1, AT 503 236 B1, AT 508 154 B1, WO 2013160313, EP 1 288 386 A1 and WO 95/32082 A1.

WO 95/32082 A1 describes a wood component with layers, which are bound to one another, wherein the layers are constructed of boards, which each have a grooving on main surfaces, which face one another. The boards of two layers, which adjoin one another directly, are oriented aslant or diagonally to one another, respectively. At the contact surfaces of adjoining layers foreign matter in the form of a foam-glue mixture can be arranged as filler in cavities, which are formed by grooves and which are substantially closed off from the outside.

DE 195 23 131 A1 describes a wall in wood frame construction, which comprises panels for the dry interior construction, bound wood fiberboards, a planking made of boards and insulating material, for example cork plates. This wall is very heavy and has low thermal insulation properties as compared to the cost of materials.

EP 1 674 224 B1 describes the manufacture of wood fiber insulating elements, where plastic granules are scattered onto a pre-fleece and the pre-fleece is subsequently defibered, mixed and blown onto a transport belt. The plastic granules, which were mixed in, are to attain an adhesion of the wood fibers by means of the subsequent heating and cooling. In spite of the undesired large processing and energy expenditures, a sufficient homogeneity can barely be ensured. The insulation characteristic of the insulating material, which is created, prevents that a homogenous temperature distribution in the material, which is to be adhered, is attained in a sufficiently quick manner. The high temperature required for the adhesion rules out the selection of heat-sensitive, in particular extremely dry thin wood fibers. In addition, the shrinkage, which occurs in response to the cool-down, can destroy bonds, which are not sufficiently firm yet.

EP 1 027 505 B1 describes the manufacture of insulating material made of organic fiber material. The manufacture of a fibrous pulp, the washing and drying, as well as the repeated defibring is associated with high processing and energy expenditures and large quantities of waste water. The adding of the cellulose-based adhesive is possible only with great difficulty in the required even distribution.

WO 2011/015714 describes a fiber insulating material, which comprises synthetic bonding fibers comprising lengths of at least 30 mm, which are at least ten times larger than the organic fibers connected thereto. In the case of these large differences in lengths, it is difficult to introduce the bonding fibers in a sufficiently homogenous manner. The high melting temperatures of above 200° C. highly limit the organic fibers, which can be used. The described polymers can also release noxious gases in response to the heating.

DE 10 2004 025 323 A1 describes the chipping of sawn wood packages by means of cutting blades arranged on the side surface of a rotating disk. The product, which is created, consists of wood particles, which are not suitable for the manufacture of lightweight insulating material or heat insulating material, respectively.

The wood chips, which are created by machining of wood and the sawdust are comminuted with high expenditure of energy and are pressed into pellets. The remaining energy value of the wood chips in the pellets is highly reduced due to the additional energy expenditure for the machining.

The object according to the invention is now to find a simple solution, by means of which construction material can be manufactured with little effort in such a way that it has good load properties and/or good thermal insulation properties, wherein the required material is to originate from as few different sources as possible. Based on the used weight of the base material, construction material comprising an overall volume, which is as large as possible, is to be created. Preferably, the construction material is to be capable of being used in buildings at earthquake-prone locations.

The object is solved by means of lightweight construction elements comprising the features of claim 1, by means of the method for manufacturing a lightweight construction element according to claim 7, by means of a lightweight panel comprising the features of claim 12, by means of the use of these lightweight construction elements and/or panels for creating a building structure according to claim 15, as well as by means of an insulating material comprising the features of claim 16.

A lightweight construction element according to the invention comprises at least one lightweight panel and a layer of insulating material associated with the lightweight panel, wherein the at least one lightweight panel comprises boards, which, on at least one of the main surfaces thereof, have a group of grooves, which run parallel, and which are arranged in at least one layer and are connected to one another via adhesive bonds. The layer of insulating material comprises wood chips, which are removed from starting boards during the manufacture of boards comprising grooves for the lightweight panel.

A method according to the invention allows manufacturing a lightweight construction element comprising at least one lightweight panel, which comprises boards comprising at least one group of grooves, which run parallel, and the lightweight construction element comprising a layer of insulating material associated with the lightweight panel, wherein the method includes removing wood chips from starting boards, at least partially using the wood chips to manufacture the layer of insulating material, providing boards with grooves, and joining the grooved boards to form at least one layer of the lightweight panel.

According to an inventive use, lightweight construction elements comprising at least one lightweight panel and insulating material comprising wood chips, which result during the manufacture of the lightweight panel, are applied in a building structure, adjoining one another in an interlocking manner and being held together by means of connecting and/or clamping elements.

A lightweight panel according to the invention comprises boards or sections of boards (6), which boards or sections, respectively, have, on at least one of the main surfaces thereof, a group of parallel grooves and are arranged in at least one layer and are connected to one another via adhesive bonds, wherein at least a part of the grooves of the boards or sections, respectively, of the at least one lightweight panel, have grooves with a width increasing away from the main surface towards the interior of the board or section, respectively, and the webs of wood formed between these grooves accordingly become wider from the interior of the board or section, respectively, towards the main surface, and have a wide web surface on the main surface.

An insulating material according to the invention comprises wood chips, which are removed from starting boards during the manufacture of boards with grooves, wherein the wood chips are substantially embodied in a strip-shaped and flat, corrugated, roll-shaped, spring-shaped or spiraled manner, and at least 80 percent by weight of the wood chips of the insulting material are formed by chips of a length in the range of between 2 mm and 40 mm. The wood chips, together with a binding agent, form a substantially cohesive structure. The binding agent comprises at least one portion of an organic binder and/or of an inorganic binder, wherein the organic binder is preferably a polymer binder, preferably polyvinyl acetate (PVAc), and the inorganic binder is preferably an alkali polysilicate-based binder, preferably a mixture of sodium silicate and/or potassium silicate comprising lithium silicate.

These subject matters of the invention comprise a common inventive idea. When solving the object, it was recognized in an inventive step that, based on dry boards, two different components, which are combined again for creating a lightweight construction element according to the invention, can be manufactured systematically at the same time. The first component is formed by boards comprising parallel grooves embodied on the main surfaces thereof, and the second component is formed by the material removed by machining, preferably by forming of the grooves. The weight of the boards is reduced by the weight of the material removed with the formation of the grooves. The stability thereby reduced in the individual boards is increased again by shaping and suitable mutual arrangement and connection or adhesion of the boards, respectively, in a lightweight panel of desired manner. The second component, the removed material, is embodied as lightweight insulant or insulating material, respectively, and is arranged in such a manner in contact with lightweight panels that the combination of at least one lightweight panel with the insulating material, which is created by forming grooves in the boards for lightweight panels, forms a stable and heat-insulating lightweight construction element.

When assembling lightweight panels, at least two layers with grooved boards, which are laterally bound together, are adhered to one another on adjoining main surfaces, wherein the grooves in the adjoining main surfaces of two layers run preferably at an angle relative to one another. Due to the fact that the grooves form weakening lines of the boards or layers, respectively, the grooved boards or grooved layers, respectively, are weakened with regard to mechanical loads at right angles to the longitudinal groove directions. The webs embodied on both sides of the grooves all the way to the main surfaces ensure furthermore a high stability in the direction of the longitudinal groove directions.

The orientations of the boards or of the grooves, respectively, of two layers, which adjoin directly, are chosen in such a manner that the load-bearing capacity of the lightweight panels corresponds to the use thereof. If the load-bearing capacity in the longitudinal direction of the lightweight panels must be as large as possible, an acute angle of at least 25° is chosen between the longitudinal groove directions of directly adjoining layers. If the load-bearing capacity is to also be large in the transverse direction of the lightweight panels, an angle of 90° is chosen between the longitudinal groove directions of directly adjoining layers. For many applications, angles in the range of between 25° and 90°, in particular the angles 45° and substantially 60° or 30°, respectively, are preferred angles between the longitudinal groove directions of directly adjoining layers.

The material removed by processing the boards, in particular by forming the grooves, or the second component, respectively, is optimized to the function as insulant or insulating material, respectively, directly at the removal. For this purpose, a machining is used, removing the substantially strip-shaped chips. The removed chips have a distribution of chip lengths and a distribution of chip thicknesses. The removal of the chips is designed to being able to use the chips to form an insulating material, which provides a large cavity part comprising a large division, remains stable and retains as little moisture as possible, after being arranged in the lightweight construction element.

Corresponding to the machining, the chips differ in the size composition thereof according to the used processing technology, the used wood type and the chosen direction of the grooves relative to the fiber direction of the boards. The grooves are preferably formed by means of circular saw blades. The diameter of the circular saw blades, the distance of the saw teeth, the shape of the saw teeth, the circumferential speed of the saw teeth and the relative feed speed between a processed board and the at least one circular saw blade can be chosen in such a manner that chips comprising the desired size composition are created.

Due to the fact that a plurality of grooves, preferably at least four grooves, can be arranged in a main surface of a board, they can be embodied in parallel by means of a plurality of circular saw blades, which are arranged at a distance from one another on a common shaft. If grooves are formed on both main surfaces of the boards, a shaft comprising a plurality of circular saw blades is assigned to each board main surface.

The engagement of the circular saw blades or of the teeth thereof, respectively, with the boards preferably corresponds to the desired groove depth, so that the groove can be formed in one operating step. If necessary, the groove is formed in more than one step, wherein each partial step removes a part of the groove, in particular of the groove depth.

A tooth of a rotating circular saw blade, which newly engages with the board, removes wood on its entire path until exiting the board, wherein the removed wood forms a chip. The chip length depends on the curvature of the outer edge of the circular saw blade and on the groove depth or on the depth of the engagement of the circular saw blade with the board, respectively. The chip width depends on the width of the teeth of the circular saw blade. The chip thickness or an expansion vertically to the chip length expansion, respectively, and to the chip width depends on the relative feed speed between a processed board and the at least one circular saw blade, on the distance (center angle or circumferential section, respectively) between consecutive teeth and on the speed of the circular saw blade.

Preferably, teeth are used, which, using straight cutting lines, create flat strip-shaped chips, which often have a corrugated shape after the separation and the movement through the clearance in the circular saw blade associated with the respective tooth. If teeth are used, which have curved cutting lines, the chips, which are created, have a curved shape at right angles to the longitudinal extension thereof, which has the result that concave cavities are embodied on the chips. If necessary, the cutting lines are also embodied in such a manner that roll-shaped, spring-shaped or spiraled chips are created, which also at least partially enclose inner spaces or cavities, respectively.

Chips can also break during the removal, wherein the partial chips, which are created, in each case form a section of the maximum chip length, which is to be expected. Whether or not the chips break depends inter alia on the shape and sharpness of the teeth and on the clearances in each case preceding them in direction of rotation in the circular saw blade. In addition, the type of the wood and the orientation of the groove relative to the longitudinal board direction or to the longitudinal direction of the wood fibers, respectively, also plays a role. To manufacture as many chips as possible in the achievable overall length thereof, the longitudinal directions of the grooves are laid out parallel to the longitudinal direction of the boards and cut-off saw blades comprising sharp teeth and clearances upstream of the teeth, which correspond to the chips, which are created, are used. If only a few chips break, the proportion of the fine material in the removed insulating material is very small and the chip length distribution is narrow.

In order to form as many chips as possible from the removed material of a groove, the chip thickness is chosen to be as small as possible, wherein a minimum thickness is not to be fallen below, so that the chips are still stable enough and have a substantially constant width across a length range, which is as large as possible. If a large number of chips is removed from a predetermined groove volume, this large number of chips provides for the formation of many partial spaces, which are surrounded by chips and in which small partially enclosed air quantities achieve a high thermal insulating effect in the insulating material. The specific weight of an insulating material of high thermal insulating properties is very small in the case of chips of a small thickness. This means that only a small quantity of wood is required for the manufacture of a given volume of the insulating material.

When processing the boards for the production of lightweight panels, chips are not only created by forming grooves. The main surfaces are planed and the side edges are processed by means of a molder. Grooves and tongues are formed on the side edges of the boards by means of machining, so that the boards, which are joined to form a layer, ensure a good cohesion by means of the groove-tongue connection. The groove and tongue connections between the boards of a layer have the additional advantage that the layers can be loaded more quickly after gluing the side edges of the boards, and that the boards of the layer run along a plane so as to be flush. The boards or the layers are also planed so as to be flat, wherein further chip material is created.

During the manufacture of lightweight panels with grooved boards or layers, respectively, approx. 40% of the entire wood volume of the used starting boards remain in the lightweight panel, 60% accumulates as removed residual material in the form of chips. For the manufacture of the lightweight panels, process heat is required for the production (wood drying, heat treatment for gluing of the layers as well as for setting of the binder in the insulating material) and, if applicable, for the heating of the production facility. A portion of the removed residual material, for example approx. 25%, is used to directly create the process heat or, if applicable, with the use of a combined heat and power plant for the combined generation of heat and electrical energy. The remaining portion of approximately 75% of the residual material can be used for the production of insulating material. These percentages can be adapted to the respective requirements.

Based on 1 m³ of wood in the form of raw boards of a weight of approximately 450 kg, approximately 180 kg of this wood material ends up in the lightweight panel. Due to the fact that the cavity portion of the lightweight panel is approximately 40% due to the grooves, it can be assumed that the volume of the lightweight panel of weight of 180 kg is approximately 0.56 m³. Approximately 200 kg of the removed residual material comprising the weight of approximately 270 kg is used for the production of insulating material. Due to the fact that the density of the insulating material is approximately 60 to 90 kg/m³ and due to the fact that a large portion thereof is formed by the wood chips and a small portion, for example approximately 10%, is formed by the binding agent, this results in a volume of the insulating material of approximately 2.5 m³ to 3.5 m³.

If, after deducting approximately 70 kg, the energy of which is used for the production, all of the material, which is created from 1 m³ wood, is assembled in the form of the lightweight panel and of the insulating material, an installable volume of between 3 m³ and 4 m³ is created. Due to the fact that only a part of the lightweight construction elements for a house comprise insulating material, only a part of the wood chips, which are created, is mostly used together with the lightweight construction elements, which are made of the same wood. The remaining part can be used as insulating material, separately from the lightweight construction elements or, if applicable, as energy carrier. The use as energy carrier, however, is less efficient, because a lot of additional energy must still be expended for the processing, for example for manufacturing pellets.

A circular saw blade comprising a diameter, which is as large as possible, where, due to the weak curvature of the outer edge of the circular saw blade, a long segment of the outer edge thereof is accommodated in the board or in the groove, which is created, respectively, is chosen for removing long chips. If the groove depth can be chosen, it is chosen so as to be larger, if long chips are desired. A circular saw blade comprising a diameter, which is as small as possible, where a short segment of the outer edge or circumference thereof, respectively, is accommodated in the board, is chosen for removing short chips. If the groove depth, which is carved out in a processing step, can be chosen, it is chosen so as to be smaller, if small chips are desired.

In a particularly advantageous embodiment, the chips, which are removed from the grooves of a board, which run next to one another, are embodied with different lengths. According to a first embodiment, the grooves are thus formed with different depths. Grooves of different depths can then be used in a particularly advantageous manner, when grooves are embodied in the boards on both main surfaces. So that the entire groove cavity in the board does not need to become smaller because of the grooves of different depths, the grooves together, which are in each case located opposite one another on the two main surfaces, can have a constant sum of the individual depths. If the groove on a first main surface thus only has a small depth, the groove located opposite thereto on the second main surface can have a large depth. The wood area between these grooves will then in each case have a desired minimum thickness. If the groove depths on the first main surface now increase from the side edges of the board towards the center of the board, the groove depths on the second main surface increases from the center of the board towards the side edges of the board.

According to a second particularly advantageous embodiment for the manufacture of chips of different lengths from the grooves of a board, which run next to one another, circular saw blades comprising different diameters are used. If all of the grooves of a board are manufactured by means of circular saw blades of different sizes, a chip mixture, the chip length distribution of which is wider than in the case of the manufacture of chips, by means of circular saw blades, which are all the same, follows from all of the grooves together. Each circular saw blade having a different size creates chips comprising a narrow length distribution. Due to the fact that the maxima of these length distributions have different chip lengths according to the respective circular saw blade diameter, the overall distribution formed from the sum of the individual distributions is significantly wider. A chip mixture of chip lengths, which are distributed across a desired length range, can ensure a more complex cavity structure, than chips, which all have substantially the same length.

So that circular saw blades comprising different diameters can be used efficiently while distributed across the board width, a first shaft, which is oriented at a first acute shaft angle α to the main surface of the boards, which are to be processed, and on which circular saw blades comprising an increasing diameter are arranged at predetermined intervals, is used in a preferred embodiment. The first shaft is located in a plane, which stands vertically on the main surface of the boards and is oriented vertically to the longitudinal axes of the grooves. The angle between the first shaft and the main surface as well as the diameters of the circular saw blades and the position thereof on the first shaft are preferably matched to one another in such a way that all of the circular saw blades form grooves with depths, which are substantially the same. Due to the inclined shaft, a first disk angle β is formed between the planes of the circular saw blades and the main surface, whereby the following applies:

β=90°−α

According to the inclination of the circular saw blades or of the disk angle β, respectively, the disk angle β is also formed between the lateral edge surfaces of the grooves, which are created, and the main surface of the board. So that the grooves in sectional planes vertically to the longitudinal groove direction do not maintain the asymmetric shape, a second shaft comprising circular saw blades, which is oriented at a second acute shaft angle α′ to the main surface of the boards, is preferably assigned to the same main surface. This second shaft comprising circular saw blades is oriented so as to be mirrored to the first shaft comprising the circular saw blades relative to a mirror plane, which stands vertically on the main surface and comprises the central longitudinal axis of the board, and is additionally arranged so as to be slightly offset to the first shaft in longitudinal board direction.

The two shafts comprising the circular saw blades are matched to one another in such a way that, after processing of the main surface with both shafts, substantially symmetrical groove cross sections are at hand, wherein the groove width becomes larger away from the main surface towards the interior of the board. The groove opening on the main surface corresponds at least to the expansion of the circular saw blades in the main surface vertically to the longitudinal groove direction. Webs made of wood, which become wider from the interior of the board towards the main surface and which have a wider web surface on the main surface, remain between the grooves.

When assembling lightweight panels or when gluing two layers, respectively, with grooved boards, which are laterally bound to one another, respectively, these wide web surfaces ensure sufficiently large contact surfaces for a stable adhesive bond and this also independent from the angle between the grooves in the adjoining main surfaces of the two layers. In response to moisture changes, the associated swelling and shrinkage deformations in the webs, which are adhered to one another, are maximal, due to the different web orientation in different directions. The differences under swelling and shrinking result from the fact that the corresponding properties are very different in a tree trunk. The expansion changes in longitudinal trunk direction or axially, respectively, are 0.1 to 0.3%, radially 1 to 3% and tangentially 3 to 6%. If board areas comprising a tangential shrinkage behavior are now fastened to board areas comprising an axial shrinkage behavior, the length change percentages can differ by the factor 20. The large adhesive contact surfaces between webs of the two layers can absorb the forces, which occur, without deformation of the lightweight panel, or without the formation of tension cracks, respectively.

If after the processing of a main surface of a board comprising two inclined shafts, which are arranged in a mirror-inverted manner, comprising circular saw blades of different sizes, protruding central webs are still embodied in the centers of the grooves on the groove bases, they can be advantageous for individual applications, while they are removed for other applications. Circular saw blades of the same size, which are arranged at corresponding intervals on a shaft, which runs parallel to the main surface and vertically to the longitudinal groove direction, are used for the removal. After the removal of the central webs, grooves are created, the cavity part of which increases from the respective main surface towards the inside, all the way to a central cohesive wood layer. It goes without saying that the central areas of the grooves can also be removed prior to the lateral areas.

The central cohesive wood layer can absorb forces, which are applied into the grooved board via the side edges. After the gluing of layers comprising grooves of different orientations, these transverse forces are absorbed by the webs of the adjoining layer, because these webs run aslant to the side edges of the boards of the first layer or preferably cover the groove openings in the case of parallel boards. If the grooved boards are used in lightweight panels comprising at least two layers, the cohesive wood layer can be embodied so minimally that it substantially only holds together the web arrangements at the transport of the board for the manufacture of the lightweight panels.

So as to create a board comprising an overall groove volume, which is as large as possible, the described groove forming steps are carried out on both main surfaces in a preferred embodiment. For this purpose, two shafts, which run in a mirror-inverted manner at an acute angle to the second main surface, comprising circular saw blades of different sizes and in particular a shaft, which runs parallel to the second main surface, comprising circular saw blades of the same size, are used.

The arrangement is in particular chosen in such a manner that, in the board cross section, the webs, which lead away from the central cohesive wood layer on both sides, are formed so as to substantially be mirrored to a central plane. Compressive forces, which are absorbed by the webs across the wide web surfaces on the first main surface, can be transferred directly to the webs, which extend from the middle of the board towards the second main surface. In the case of this arrangement, a central cohesive wood layer of thickness of only 5 to 15% of the thickness of the board is preferably sufficient. These embodiments, which are geared towards high compressive loads of the main surfaces, are suitable for lightweight construction elements, for example, which are used for floors or ceilings, respectively.

If necessary, however, the webs are displaced relative to one another on both main surfaces, so that grooves on the second main surface are assigned to the webs on the first main surface. So that compressive forces can be transferred well from one main surface to the other, the central wood area is formed in such a manner that the forces from one web of the first main surface are divided or transferred, respectively, to two adjacent webs of the second main surface as optimally as possible. For this purpose, the central cohesive wood layer needs a corresponding shape and in particular more material, wherein the respective chosen shaping can be oriented to desired deformation properties of the lightweight panel. For building walls in earthquake-prone areas, it is advantageous, if high deformation energies do not lead to the complete breakage of the lightweight panel, but create large deformations in the panels, in particular with local material failures in the central cohesive wood layer, which are able to absorb large energy portions in a dampening manner.

When grooves extend in longitudinal direction of the boards, the webs extend parallel to the longitudinal direction of the wood fibers, which increases the stability of the webs. It is also possible to embody a second group of parallel grooves at an acute angle to the first group of grooves. The web surfaces between the first grooves and obviously also the webs are interrupted through this. Contact surfaces, which are sufficiently large for a stable adhesive bond, are still present when assembling lightweight panels or when gluing two layers with grooved boards, which are laterally bound to one another, in each case comprising groove groups, which run at an acute angle to one another. Together with the adjoining webs or web sections, respectively, the adhesive bonds form a grid structure comprising large connecting lengths in the case of uninterrupted webs, and a netty structure comprising shorter connecting lengths in the case of interrupted webs.

The combination of the stability structure formed by the adhesive bonds and the web arrangements, and the deformation options given by the groove bases and the central cohesive wood layer, can be adapted optimally to the desired demands.

When two layers comprising grooves, if applicable on at least one main surface comprising two cross groups of grooves, are glued, the adhesive bonds are partial areas of the layer surface, in which the webs of the two connected layers, which protrude between the grooves, adjoin one another with their web surfaces. There is no large-area or cohesive glue layer, respectively, which could limit the moisture permeability vertically to the layer surface in an undesirable manner. The cavities formed by the grooves exist in the vicinity of the adhesive bonds or the web surfaces, respectively. If bending forces act on the lightweight panel, they do not lead to the sudden breaking of the lightweight panel by exceeding an elasticity limit, but webs are deformed locally into the fillable cavities. These small inner deformations and breaks or entanglements, respectively, can absorb a very large amount of energy, without resulting in breakage of the lightweight panel. The lightweight panel has a high elasticity and still has a high remaining bending strength, even after absorbing a large amount of deformation energy as well as a strong deflection, which is associated therewith.

If a lightweight panel is constructed of more than two layers, the two outer layers are made up differently in a preferred embodiment than inner layers located therebetween. The inner layers can have a smaller stability and accordingly a larger cavity part than the outer layers with regard to compression or stretching, because inner layers ensure that the compression and stretching stress of the overall panel is substantially divided onto the two outer layers. The inner layers, however, must ensure that the distance between the outer layers remains substantially unchanged. For this purpose, they must have a sufficiently large compressive strength vertically to the main surface. An optimal design of the groove forms and arrangements in the various layers can be adapted to the expected loads by means of model calculations.

In a preferred embodiment, a layer of boards, which comprise a group of grooves only on the main surface, which is directed towards the interior of the lightweight panel, is arranged at at least one outer surface of the lightweight panel. On its main surface, which is directed towards the exterior of the lightweight construction elements, the boards comprise edge areas or chamfers, respectively, which are milled along both long side lines. If the lightweight construction elements comprising the boards comprising the milled edge areas or chamfers, respectively, are used so as to be oriented to the outside as wall element, milled edge areas or chamfers, respectively, run diagonally downwards as small grooves and can thus deflect the rain water, which hits the respective board, to the side in a controlled manner, which prevents a different wetting and thus a different vegetation or a different discoloration, respectively, of the upper and lower areas of a wall.

In the lightweight panels constructed of layers comprising boards, the boards extend in directions parallel to the plane, which is defined by the longitudinal and the transverse direction of the lightweight panel. The smallest changes in length in response to swelling and shrinking result in the longitudinal board direction or in the longitudinal direction of the wood fibers, respectively, because the expansion changes in longitudinal trunk direction or axially, respectively, are only between 0.1 and 0.3% in the case of a tree trunk. In the case of the described lightweight panels, the minimal expansion changes accordingly result in the plane of the lightweight panel. Larger expansion changes appear vertically to the plane of the lightweight panel or vertically to the main surfaces of the boards of the lightweight panel, respectively, because this direction in the grown tree comprises components in a radial direction and/or a tangential direction and the expansion changes are 1 to 3% radially and 3 to 6% tangentially. For applications, where the outer surfaces or the main surfaces, respectively, of the lightweight panels are to remain as accurately as possible in a plane, regardless of the respective ambient moisture, the lightweight panels must be adapted to this additional object.

In a preferred embodiment short sections of the same length are by means of cuts separated from lightweight panels with main surfaces of the boards oriented parallel to the outer surface of the lightweight panel, wherein the cuts are made in normal planes to the outer surface of the divided panels. These short sections are confined by two cut surfaces being parallel to each other, and vertically thereto by two partial surfaces of the outer surfaces of the divided lightweight panels. The short sections are rotated by 90°, are arranged next to one another in one layer and are brought into mutual connection with the partial surfaces of the outer surfaces of the divided lightweight panels, so that they form a layer of sections, in particular a core layer, of a further optimized lightweight panel. By connecting, adjoining sections are placed against one another with their partial surfaces of the original outer surfaces and are preferably connected to one another via adhesive bonds at that location. The cut surfaces of the connected sections now form the new outer surfaces of the layer of sections.

In the layer of sections, the longitudinal directions of the wood fibers no longer run substantially parallel to the layer outer surface, but at right angles thereto. The effective orientation thereby depends on the orientation of the cut surfaces when cutting sections relative to the longitudinal board directions of the divided panels.

In a preferred embodiment, the lightweight panel, from which the sections are separated, only comprises boards comprising the same orientation and the cut surfaces are oriented substantially vertically to the longitudinal board direction. The longitudinal direction of the wood fibers in a lightweight panel, which is constructed of sections of a lightweight panel comprising boards, which are oriented substantially identically, in the described manner, run substantially vertically to the outer surfaces of a layer of such sections. Accordingly under swelling and shrinking, the smallest changes in length occur in the direction vertically to the outer surfaces of the layer and therefore the outer surfaces of the lightweight panels, which are at least partially constructed of sections, remain in one plane as accurately as possible, even when moisture changes.

Layers of boards comprising grooves, with the groove width increasing away from the main surface towards the interior of the board, have webs with the web surface on the main surface of the layer being wider than the groove opening, between the grooves. If such layers are now connected to one another in the same groove or board orientation, respectively, the web surfaces can span the access openings to the grooves, which results in a continuous connection layer, respectively, due to the gluing. An angle between the grooves of the layers, which adjoin one another directly, can be foregone, without thereby substantially limiting the stability of the panel, which is created.

If layers with the same groove or board orientation, respectively, are connected to one another in such a way that the web surfaces of the two connected layers substantially meet each other exactly, this results in a large adhesive bond, which, however, is interrupted by the groove accesses. Due to the fact that the boards comprise a central cohesive wood layer on the respective base of the grooves thereof, a stability, which is sufficient for many applications, is created in the lightweight panel in spite of the cohesive cavities, which are large as a whole and which are in each case formed by two grooves. In particular, separated sections of this lightweight panel also have stability, which is sufficient for the further processing.

A disadvantage of the solution according to EP 1 913 211 B1 can be overcome by means of the above-describe preferred solution, where the wood fibers substantially form an angle of 90° to the outer surfaces of the layer of sections. There, the longitudinal directions of the fibers to the outer surface of the layer always have an angle in the range of between 25° and 80°. An angle of 90° is impossible in the solutions of EP 1 913 211 B1.

If the lightweight panel, from which the sections are separated, comprises at least two layers comprising differently oriented boards, the cut surface is preferably chosen in such a manner that the surface normal axis to the cut surface forms angles, which are as small as possible, to the different longitudinal board directions. Accordingly, the different longitudinal directions of the wood fibers comprising angles, which are as small as possible, differing from the direction vertically to the cut surfaces of a layer of such sections. The smallest changes in length in response to the swelling and shrinking result in the direction, which differs slightly from the direction vertically to the outer surfaces of the layer. The main or outer surfaces, respectively, of the lightweight panels, which are at least partially constructed with sections, can carry out movements, which are only slightly above the obtainable minimal movements, in response to moisture changes.

This solution, with the longitudinal directions of the wood fibers differing from the direction vertically to the outer surfaces of a layer of such sections, has another advantage as compared to the solution according to EP 1 913 211 B1. In the case of the solution according to EP 1 913 211 B1, the grooves extend from one main surface of a board across the majority of the thickness of the board, which can lead to stability problems when separating sections. In the case of the invention at hand, the central cohesive wood layer ensures the stability, which is required for the separation.

A further layer of sections or a cover layer can be arranged or adhered, respectively, on each new outer surface of a layer of sections. The respective desired surface can be provided by means of a cover layer. All of the materials, which are known as cover layers, can be used accordingly. The lightweight panels, which are at least partially constructed of sections of lightweight panels, can also be used in lightweight panels for furniture and interior decorations in addition to the use in lightweight construction elements, whereby cover layer elements are then also adhered to the front sides.

In the case of lightweight panels for furniture and interior decorations comprising thin cover layers, it is problematic, if there are cavities comprising large diameters in all directions below the cover layer, because the load-bearing capacity of the cover layer and the fastening options are highly limited at that location. In a preferred embodiment of the lightweight panel comprising at least one layer of sections of a lightweight panel comprising grooves where the groove width increases away from the main surface towards the interior of the board, ridges made of wood, which protrude into the groove, are left at the groove base. This means that circular saw blades, which are inclined only in two different directions, are used when forming these grooves, and that the use of the circular saw blades, which are oriented vertically to the main surface of the boards, is foregone. Accordingly, there are substantially only narrow cavities, which have a small expansion in one direction, which corresponds to the thickness of the circular saw blade, by means of which the groove was formed. This thickness is preferably substantially 4 mm.

To provide a lightweight construction element of good thermal insulation, a layer comprising wood chips is arranged on a lightweight panel, preferably between two lightweight panels, which are connected to one another, wherein the wood chips are produced by processing of dry boards or layers, respectively, for lightweight panels.

In the simplest case, the wood chips are simply filled into cavities of lightweight construction elements, which are substantially closed against the outside. To prevent a slow gravity-driven sagging or aging-related disintegration of the chips, respectively, a binding agent is added to the chips, which, evenly distributed, ensures minimal bonds between the wood chips. The addition of the binding agent can take place directly when filling the wood chips into cavities. In the case of a further preferred embodiment, mat-shaped insulating elements are manufactured, which are fastened to lightweight panels. During the manufacture of the mat-shaped insulating elements, a forming process, which provides the insulating elements with the desired shape and stability, is carried out after adding the binding agent.

The preferred binding agent is in each case adapted to the application. It is important thereby, how quickly a minimal stability must be reached and whether the hardening process can be supported. In the case of chips, which are filled into a cavity, the demand on the optimal binder is different than in the case of chips, which are joined to form mats. In addition, the binder composition can also be geared towards fire protection requirements and/or on the protection against biological degradation processes.

A versatile binding agent preferably comprises a portion of an organic binder and a portion of an inorganic binder, wherein these two binders must be compatible with one another.

A polymer binder, for example polyvinyl acetate (PVAc), in the form of a solution, is used in an organic solvent or preferably as dispersion is preferably used as organic binder. Polyvinyl acetate is an amorphous, odorless and flavorless synthetic material, comprising a high light and weather resistance. Even though it is combustible, it is not easily flammable.

Alkali polysilicate-based binders are suitable as inorganic binders. Alkali polysilicates are (amorphous) solids, which are crystalline or glass-like as mixture of different silicates, or are viscous solutions in water, respectively. They comprise at least one of the alkali metals lithium, sodium, potassium, rubidium, cesium or francium, wherein alkali polysilicates comprising sodium and potassium are the most widespread in the form of sodium silicate.

Depending on the binders, which are used, silicate paints and dispersion silicate paints are known from the field of paints. In addition to alkali polysilicates or sodium silicate respectively, dispersion silicate paints also include an organic binding agent, commonly a synthetic resin dispersion. This is why dispersion silicate paints are also identified as organosilicate paints. According to DIN 18363, dispersion silicate paints can comprise maximally 5 percent by weight of organic components. Common silicate paints are composed as two-component products and consist of liquid sodium silicate (binder) and a powdery pigment filler mixture, wherein these two components are brought together only shortly prior to the processing, because the pigment particles sediment at longer downtimes. To achieve bonds between the wood chips, the binder component of commercially available silicate paint can thus be used.

DE 26 52 421 A1 describes an alkali polysilicate-based binding agent, which consists of a mixture of sodium silicate and/or potassium silicate comprising lithium silicate. A small portion of lithium silicate already increases the water resistance in the set state and ensures a slightly lower pH value. In addition, the efflorescences, which occur in response to the setting of sodium silicate, can be avoided with the portion of lithium silicate.

In the case of ready-to-use alkali polysilicate-based binders, the alkali polysilicates are already dissolved in water. An organic binder, in particular polyvinyl acetate (PVAc), can be used as aqueous dispersion. To be able to ensure a bonding structure, which is as homogenous as possible, in a number of wood chips, the aqueous binder must be brought into contact with as many wood chips as possible as evenly as possible. The aqueous binder is introduced into a material flow of the chips via nozzles directly while filling the wood chips into cavities, or during the manufacture of the mat-shaped insulating elements.

A binding agent with portions of regrowing raw materials is preferably used for the manufacture of the insulating material. Such binding agents can comprise tannins, technical lignins, carbohydrates, such as starch, e.g. or also proteins, e.g. casein. In the combination with wood chips, the tannins, which are widespread in nature and which are present in hydrolysable as well as in condensed form, are particularly advantageous. The production is directed mainly to condensed tannins, which are in particular manufactured from tree barks. Preferably, binding agents comprising tannin and additives, for example comprising hexamine, are used, where only small formaldehyde emissions appear. Due to their chemical structure, tannins can be converted into highly-molecular condensation products comprising high hardening speeds. The properties of tannin resins can be improved by adding isocyanates.

During the manufacture of the mat-shaped insulating elements comprising wood chips, the binding agent must form bonding bridges in the contact areas between wood chips, which are brought together loosely. For this purpose, the binding agent is formed and is supplied to the wood chips in such a way that the wood chips are wetted sufficiently with binding agent and that binding agent forms bridges between wood chips in response to the subsequent setting and the insulating material, which is created, is air-permeable. To achieve the desired wetting property, a wetting agent and/or a foaming agent and/or a solvent, in particular water, is added to the binding agent, if necessary. To achieve a particularly quick setting, a two-component binder is used, if necessary.

In a preferred embodiment, the chips as well as the aqueous binder are charged electrostatically. The two components are in each case oppositely charged, so that an optimal distribution of the binder across the wood chips results when the charges meet or in response to the charge equalization, respectively.

When filling a cavity, the charged chips can be supplied through a pipe, wherein nozzles for the charged binding agent are assigned to the pipe end. In a manufacture of mat-shaped insulating elements, at least one carrier belt and an application device for the layered application of the preferably charged chips to the carrier belt as well as a pressing belt are used on a hardening path. The application device also comprises a nozzle arrangement for introducing the preferably charged binding agent. Further partial layers can be applied to the first layer of chips, which is permeated with binding agent, by means of one or a plurality of further application devices. The layer thickness of the individual partial layers can be chosen to be so small that the wetting with the binding agent in the overall layer, which is created, is substantially homogenous. When passing through the hardening path between carrier belt and pressing belt, bonding bridges are formed between the wood chips to the extent that the mat-shaped insulating layer, which is created, holds together. To accelerate the hardening, it is preferred to supply heat and air, if necessary.

Lightweight construction elements and lightweight panels can be assembled easily, when they comprise groove and/or tongue elements. A building structure comprises lightweight construction elements and lightweight panels for side walls, partition walls, floors or ceilings, respectively, and roof surfaces, if necessary. When erecting the building structure, adjoining lightweight construction elements and lightweight panels, if necessary, are bound to one another with their side edges. In an advantageous embodiment, element or panels, respectively, which are connected to one another, comprise grooves, which are assigned to one another and with which corresponding tongues of connecting elements engage. If necessary, the grooves face one another and in each case widen towards the interior of the element or of the panel, respectively, so that a closing element, which is adapted to the two groove cross sections, can simultaneously be inserted into both grooves, so as to hold the elements or panels, respectively, together.

Instead of closing elements comprising a fixed form, which can be inserted into the grooves, preferred embodiments comprise a clamping device, moving grooves, which face one another, of lightweight constructions elements, which are to be connected, comprising contact surfaces of the clamping device into a desired contact position in response to the clamping of the clamping device. The grooves are in particular formed on groove parts or frame parts, respectively, of the lightweight construction elements or lightweight panels. The clamping device preferably comprises at least one arrangement, in each case comprising two clamping elements, which can be moved towards one another by means of at least one clamping screw or a clamping actuation, if necessary, wherein guide surfaces of the clamping elements, engaging with matching groove surfaces, run in an acute angle to the screw axis or to the clamping direction, respectively, and move the lightweight construction elements or lightweight panels, respectively, which are to be connected, into the desired contact position in response to the movement of the clamping elements towards one another by means of the forces acting on the groove surfaces. Groove parts and the clamping elements preferably extend across the entire expansion of the side edges of the lightweight construction elements.

The screw axes or the clamping devices, respectively, are substantially vertical to the large outer surfaces of similar oriented lightweight construction elements and the clamping screws or clamping actuations, respectively, can be operated from one side of the lightweight construction elements. It goes without saying that such clamping connections can also be arranged between differently oriented lightweight construction elements, for example as corner connections, between lightweight construction elements and other components, for example ceilings or floors, respectively.

When the tightened connection is fixed by means of an adhesive, the clamping screws or the clamping acutations, respectively, can be removed after the hardening of the adhesive, and a connection, which is free from metallic parts, is created. The lightweight construction elements according to the invention make it possible to construct the walls, ceilings and floors of houses in a completely metal-free manner, so that the shell consists only of wood, adhesive, wood chips and binding agents for connecting the chips, if necessary.

After the tightening, the clamping device can be covered by means of cover strips, which are inserted between the large outer surfaces of the connected lightweight construction elements. If necessary, insulating material, in particular an insulating strip, is arranged between a clamping device and the assigned cover strip.

It goes without saying that all of the connecting means, which are known from the prior art, can be used, in particular also tightening straps, which ensure a certain resilience and mutual displaceability of the wall elements in response to earthquakes. If the lightweight construction elements are not glued, a disassembly is possible without destroying lightweight construction elements.

A significant advantage of the invention is that all of the aids, which are required for the creation of the lightweight construction elements, such as machines and the operating steps, which are to be carried out, are so simple that they can be carried out by workers, who have only been trained briefly and that the machine-related effort is reduced to a minimum. The production of the lightweight construction elements can take place in the vicinity of the location comprising the building structures, which are to be created.

The invention will be specified in more detail by means of the drawing.

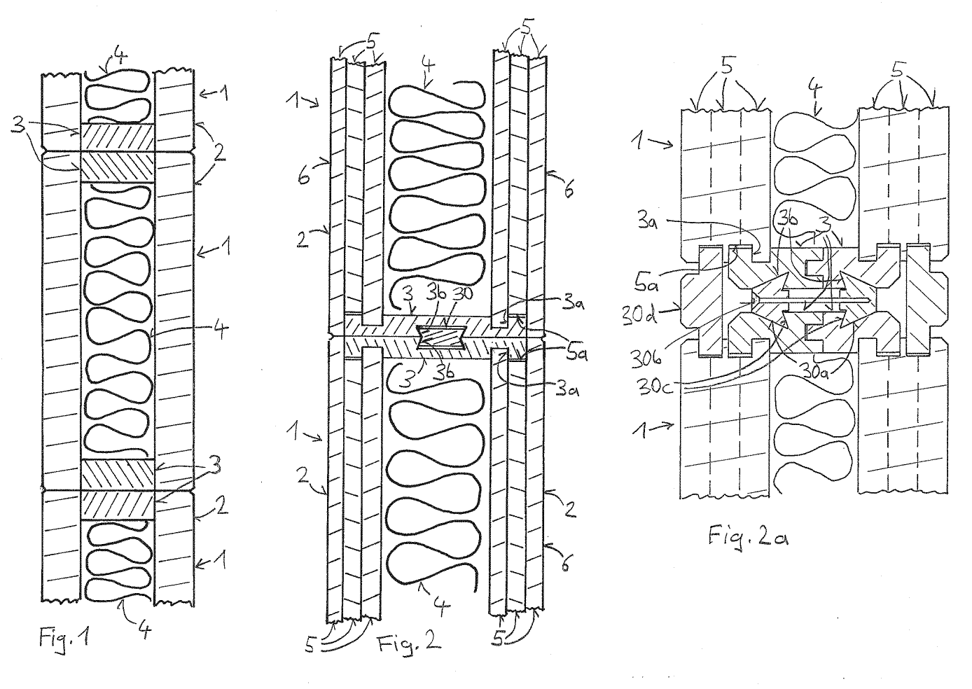

FIGS. 1, 2, 2a show sections through lightweight construction elements, which are connected to one another,

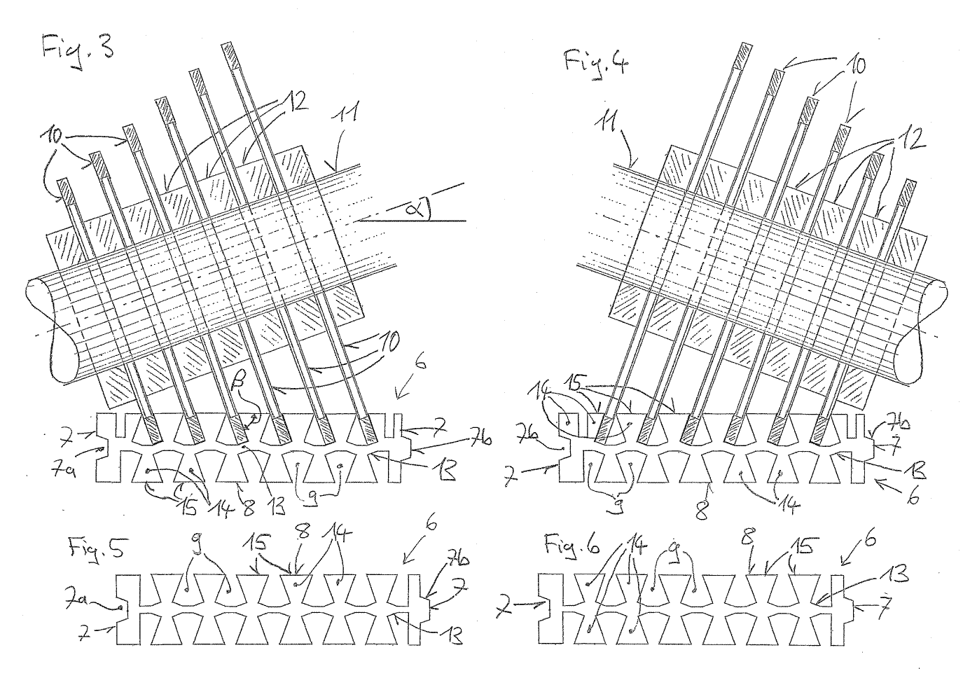

FIGS. 3 and 4 show schematic illustrations for the manufacture of grooves,

FIGS. 5 and 6 show front views of boards, which were processed analogously to FIGS. 3, 4,

FIG. 7 shows a front view of a board comprising grooves of different depths,

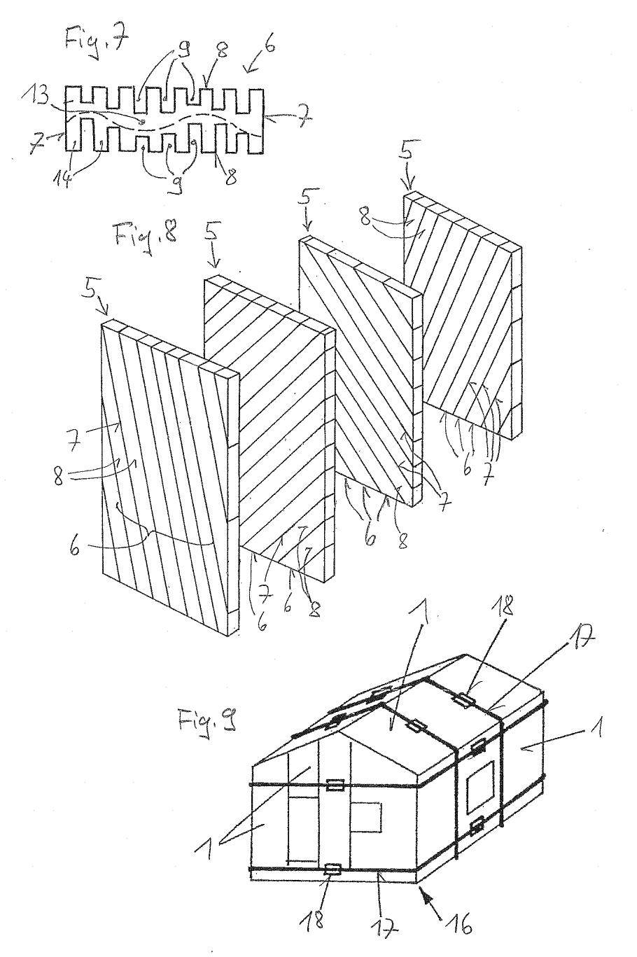

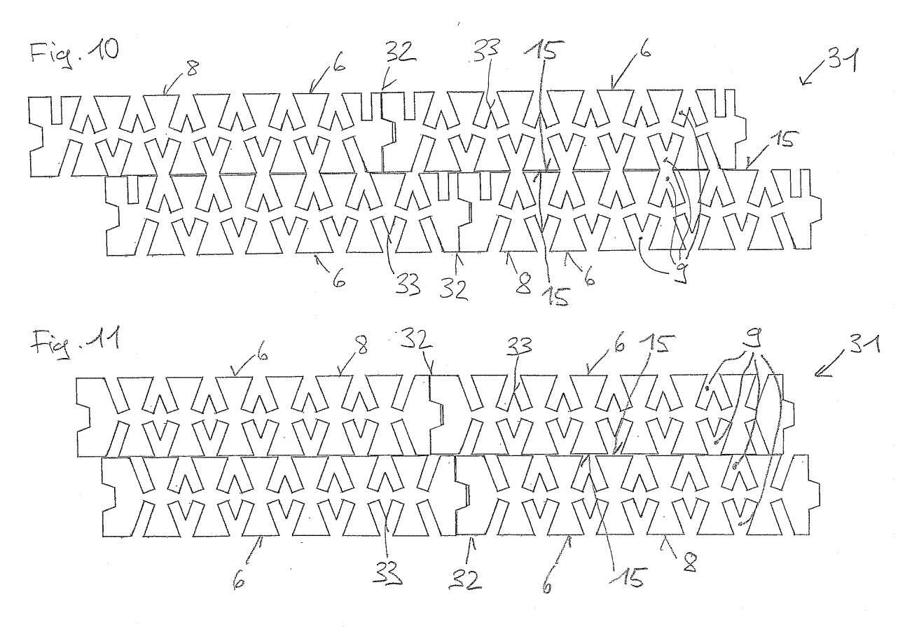

FIG. 8 shows a perspective illustration of layers of a lightweight panel,

FIG. 9 shows a perspective illustration of a building structure comprising lightweight construction elements,

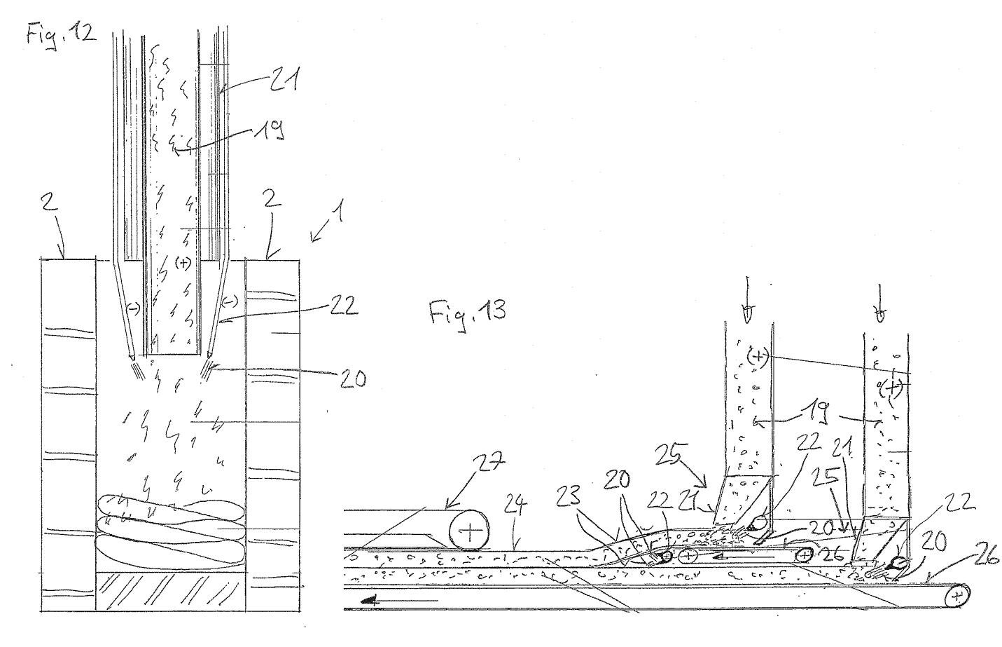

FIGS. 10 and 11 show views of sections of lightweight panels,

FIG. 12 shows a schematic illustration for filling insulating material into a cavity of a lightweight construction element,

FIG. 13 shows a schematic illustration for manufacturing mat-shaped insulating material,

FIGS. 14 to 16 show visualizations of different wood chip distributions,

FIG. 17 shows a visualization of a section of a mat-shaped insulating material and

FIG. 18 shows a section through lightweight panels, which are connected to one another, which can be used as interior walls.

FIG. 1 shows a section of three lightweight construction elements 1, which are connected to one another at side faces and which in each case comprise a lightweight panel 2 on both lateral outer surfaces. At the side faces arranged frame parts 3 hold the two lightweight panels 2 of each lightweight construction element 1 at a predetermined distance to one another, so that a cavity is embodied in the interior of the lightweight construction element 1. In the illustrated embodiment, the cavity is filled with insulating material 4. This insulating material 4 can either be filled in in the form of wood chips, preferably comprising binding agent, or can be inserted as insulating material mat when assembling the lightweight construction element 1. The lightweight panels 2 are formed by boards, which have a group of grooves, which are not illustrated, which run parallel on at least one of the main surfaces thereof.

FIG. 2 shows an embodiment analogous to the embodiment in FIG. 1, wherein the lightweight panels 2 comprise three (in FIG. 8 four) layers 5. Each layer 5 is formed by boards 6 (see FIGS. 3 to 7). The boards 6 of each layer 5 are connected by means of adhesive bonds on the side edges 7 thereof and preferably have grooves 7a and tongues 7b at that location (see FIGS. 3, 5, 8). The directly adjoining layers 5 are connected via adhesive bonds on the main surfaces 8 of their boards 6. The frame parts 3 arranged at the side faces engage with second groove tongue arrangements 5a of the lightweight panels 2 by means of first groove tongue arrangements 3a, wherein these engaging groove tongue arrangements 3a, 5a are glued to one another. So that the lightweight construction elements 1 can be connected at the side faces to one another in a simple manner at a construction site, the frame parts 3 have connecting grooves 3b, which are widened inwards, so that slats 30, which are tapered in the center, hold the lightweight construction elements 1 together after the insertion into the connecting grooves 3b.

The boards 6 have a group of grooves 9, which run parallel, at least on one of the main surfaces 8 thereof (see FIGS. 3 to 7). In a preferred embodiment, the grooves 9 run parallel to the longitudinal board direction or to the side edges 7, respectively. The grooves 9, which face one another, of layers, which are connected to one another, run at an angle to one another. In the embodiment according to FIG. 8, the longitudinal board directions run at an acute angle to one another in directly adjoining layers 5. When boards 6 are comprising grooves 9 in longitudinal board direction, then directly adjoining layers 5 have grooves 9 running at an acute angle to one another.

FIG. 2a shows an advantageous clamping connection, where frame parts 3 comprising first groove tongue arrangements 3a engage with second groove tongue arrangements 5a of the lightweight panels 2 on both lightweight construction elements 1, which are to be connected, wherein these engaging groove tongue arrangements 3a, 5a are glued to one another. So that the lightweight construction elements 1 can also be connected easily to one another at a construction site, the frame parts 3 have connecting grooves 3b. A clamping device 30a, 30b, 30c makes it possible to move the grooves, which face one another, of lightweight construction elements, which are to be connected, by means of contact surfaces 30c of the clamping device in response to clamping.

In the illustrated embodiment, each lightweight construction element 1 comprises two grooves 3b, which are embodied in a mirror-inverted manner relative to a central plane of the lightweight construction elements 1 on two groove parts 3, which are connected to one another. The clamping device preferably comprises at least one arrangement comprising two clamping elements 30a, which are formed in a mirror-inverted manner and which can be moved towards one another by means of at least one clamping screw 30b, wherein guide surfaces 30c of the clamping elements 30a run in engagement with matching groove surfaces at an acute angle to the screw axis and are oriented in such a way that the lightweight construction elements 1, which are to be connected, are moved into the desired contact position by means of the forces acting on the groove surfaces when the clamping elements 30a move towards one another.

The axes of the clamping screws 30b are at right angles, in particular substantially vertically, to the large outer surfaces of at least one of the two lightweight construction elements 1 and can be operated from one side of the lightweight construction element 1. When the tight connection is fixed by means of an adhesive, the clamping screws can be removed after the adhesive has hardened, and a connection, which is free from metallic elements, is created. If the desired connection is embodied so as to be firm, the clamping device can be provided with an insulating material, if necessary, which is not illustrated, in particular with an insulating strip, and can be covered by means of cover strips 30d. The cover strips are introduced between the large edge surfaces of the connected lightweight construction elements 1.

FIGS. 3 and 4 show the removal of wood chips from boards 6 in a schematic manner. For this purpose, circular saw blades 10 are arranged, for example six, on a common shaft 11 at regular intervals by means of spacers 12. With rotating circular saw blades 10 the boards 6 are moved in the longitudinal direction thereof below the shaft 11, wherein, with their outer edge, the circular saw blades engage with the boards 6 according to the desired groove depth.

In a first non-illustrated processing area, circular saw blades of the same size are arranged on a shaft, which is oriented parallel to the main surface 8 of the boards 6 and vertically to the longitudinal board direction. The central area of the grooves 9 is embodied by means of these circular saw blades. If the grooves are formed on both main surfaces 8 of the boards 6, a shaft comprising circular saw blades of the same size is used above and below the boards.

In a second processing area, a shaft 11 is used, which is oriented at an acute angle α to the main surface 8 to be processed of the boards 6 and on which circular saw blades 10 comprising an increasing diameter are arranged at predetermined intervals. The shaft 11 is located in a plane, which stands vertically on the main surface 8 of the boards 6 and which is oriented vertically to the longitudinal axes of the grooves 9. The angle between the shaft 11 and the main surface 8 as well as the diameters of the circular saw blades 10 and the positions thereof on the shaft 11 are matched to one another in such a manner that all circular saw blades form grooves of substantially the same depths. Due to the inclined shaft 11, a disk angle β=90°−α is formed between the planes of the circular saw blades 10 and the main surface 8.

According to the incline of the circular saw blades or of the disk angle β, respectively, the disk angle β is also formed between the lateral edge surfaces of the grooves 9, which are created, and the main surface 8 of the board 6. So that the grooves 9 do not maintain the asymmetric form in sectional planes vertically to the longitudinal groove direction, a further shaft 11, which comprises circular saw blades 10 and which is oriented at a further acute shaft angle to the main surface 8 of the boards 6, is assigned to the same main surface 8 according to FIG. 4. This further shaft 11 is oriented in a mirror-inverted manner to the shaft 11 of FIG. 3 relative to a mirror plane, which stands vertically on the main surface 8 and which comprises the central longitudinal axis of the board 6, and is additionally arranged slightly offset to the first shaft in longitudinal board direction.

The processing by means of the inclined shafts 11 and the circular saw blades 10 of different sizes, which are fastened thereto, preferably takes place on both main surfaces 8 of the boards 6, thus from above and from below.

The used shafts 11 comprising the circular saw blades 10 are matched to one another in such a manner that substantially symmetrical groove cross sections are present after the processing of a main surface 8 with all shafts 11, wherein the groove width becomes larger away from the main surface 8 towards the interior of the board 6. The groove opening on the main surface 8 corresponds at least to the expansion of the circular saw blades 10 in the main surface 8 vertically to the longitudinal groove direction. Webs 14 of wood, which become wider from the interior of the board 6 towards the main surface 8 and which have a wider web surface 15 on the main surface 8, remain between the grooves 9. These wide web surfaces 15 ensure sufficiently large contact surfaces for a stable adhesive bond by gluing layers 5, and this independent from the angle between the grooves 9 in the adjoining main surfaces 8 of the two layers 5.

A central cohesive wood layer 13 can absorb forces, which are applied into the grooved board 6 via the side edges 7. After the gluing of layers comprising grooves, which are oriented differently, these transverse forces are absorbed by the webs 14 of the adjoining layer 5, because these webs 14 run aslant to the side edges 7 of the boards 6 of the first layer 5.

The boards 6 of FIGS. 5 and 6 are arranged directly below the boards of FIGS. 3 and 4, so that it can be seen that the position of the webs 14 relative to the side edges 7 can be adjusted by means of the lateral positioning of the boards 6 relative to the circular saw blades 10. According to FIGS. 5 and 6, the arrangement of the webs 14 is chosen in such a manner that the webs 14, which lead away from the central cohesive wood layer 13 on both sides, are embodied so as to be substantially mirrored to a central plane. Compressive forces, which are absorbed by the webs 14 via the wide web surfaces 15 on the first main surface 8, can thus be transferred directly to the webs 14, which extend towards the second main surface 8, in the center of the board 6. This embodiment, which is designed for high compressive loads of the main surfaces 8, is suitable, for example, for lightweight construction elements, which are used for floors or ceilings, respectively.

According to FIGS. 3 and 4, the webs 14 of the two main surfaces 8 are displaced relative to one another, so that grooves 9 on the second main surface 8 are assigned to the webs 14 on the first main surface 8. So that compressive forces can be transferred from one main surface 8 to the other main surface in a desired manner, the central wood area 13 is embodied in such a manner that the forces from one web 14 of the first main surface 8 are divided or transferred, respectively, as optimally as possible on two adjacent webs 14 of the second main surface 8. It is advantageous for building walls in earthquake-prone regions, when high deformation energies do not lead to the complete breakage of the lightweight panel 2, but create large deformations in the panels 2, in particular with local material tears on the central cohesive wood layer 13.

FIG. 7 shows a board 6, the grooves 9 of which were prepared by means of circular saw blades of different sizes, wherein the circular saw blades are arranged on two shafts, which are parallel to the board main surfaces, below and above the board. So that a central cohesive wood layer 13 substantially has a constant thickness, the diameters of the circular saw blades, which are assigned to one another, below or above the board 6, respectively, are matched to one another.

FIG. 9 shows the use of lightweight construction elements 1 for erecting a house 16 in a schematic manner. In the illustrated embodiment, tightening straps 17, to which the desired clamping force can be applied by means of clamping devices 18, are illustrated for bracing the house 16. It goes without saying that the tightening straps 17 can also consist of strap sections, wherein the strap sections are arranged in the lightweight construction elements 1 and can be connected and tightened, if necessary, via connecting devices during erection of the house 16, so that substantially nothing of the tightening straps 17 and the connecting devices appears on the exterior of the house 16.

FIGS. 10 and 11 in each case show a section 31 of a lightweight panel, where the main surfaces 8 of the boards 6 run parallel to the outer surface of the lightweight panel and the boards 6 of both or of all layers, respectively, are oriented in parallel. The sections 31 extend vertically to the drawing plane only over a short distance. After separating a plurality of sections 31 of the same lengths, they are rotated by 90° and are arranged in a layer directly adjoining one another at the long side edges 32, which are formed by the sections of the main surfaces 8. The sections 31 of FIGS. 10 and 11 would thus be pushed against one another in the illustrated position and would be brought into mutual connection with the partial surfaces of the outer surfaces of the divided lightweight panels or the sections of the main surfaces 8, respectively, via an adhesive bond. Together, a plurality of such sections 31 form a layer, wherein the cut surfaces of the joined sections 31 form the outer surfaces of this layer. If the structure of this layer is to not be visible, cover layers are arranged on both outer surfaces of the layer and on the side edges or front sides thereof, respectively.

The sections illustrated in FIGS. 10 and 11 were separated from lightweight panels, where the groove widths become larger away from the main surface 8 towards the interior of the boards 6, wherein ridges 33 made of wood, which protrude into the grooves on the groove base, were left. This means that circular saw blades, which were only inclined in two different directions, were used when forming these grooves, and that the use of circular saw blades, which are oriented vertically to the main surface of the boards, was forgone. Accordingly, substantially only narrow cavities, which have a small expansion in one direction, which corresponds to the thickness of the circular saw blade, by means of which the groove was formed, is present in the lower area of the grooves. This thickness is preferably substantially 4 mm.

In the embodiment according to FIG. 10, lightweight panels were used, where the boards correspond to FIGS. 3 and 4 except for the ridges 33, which were left, and in the embodiment according to FIG. 11, the boards correspond to FIGS. 5 and 6, except for the ridges 33. A further difference of the embodiments of FIGS. 10 and 11 is that in FIG. 10, the web surfaces 15 of the boards 6, which are connected to one another on the main surfaces 8, substantially meet one another exactly and that the web surfaces 15 span the access openings to the grooves 9 of the adjoining boards 6 in FIG. 11.

FIG. 12 shows a step of a method, where wood chips 19 and binder 20 are introduced as insulating material into a cavity of a lightweight construction element 1. Between two lightweight panels 2, the lightweight construction element 1 comprises a cavity, which can preferably be accessed on the top via at least one access opening and which is substantially closed at least laterally and on the bottom. The wood chips 19 are supplied through a pipe 21 and the binding agent 20 through at least one line 22 comprising a nozzle-shaped outlet opening. The outlet openings of the pipe 21 and of the at least one line 22 are assigned to one another in such a manner that a binding agent can be applied to all of the outflowing wood chips as evenly as possible. In the illustrated embodiment, the wood chips and the binding agent are in each case oppositely charged electrically, so that an application or mixing, respectively, which is as complete as possible, is ensured thereby.

FIG. 13 shows a step of a method, where wood chips 19 and binder 20 are joined to form insulating material mats. In the illustrated embodiment, two partial layers 23 are combined to form an overall layer 24. It goes without saying that the overall layer can be constructed of any number of partial layers 23, wherein an application device 25 is used for each partial layer 23. Each application device 25 applies wood chips 19 onto a carrier belt 26 in a layered manner. A binding agent is applied to the wood chips 19, supplied via pipes 21, where the binding agent is applied via nozzle-shaped outlet openings by lines 22. Upper partial layers 23 are placed onto the respective partial layer located therebelow. The created overall layer 24 is guided through a hardening path between the lowermost carrier belt 26 and a pressing belt 27, wherein the pressing belt 27 presses the wood chips, which are provided with the binding agent, against the carrier belt 26. To separate sections of the overall layer 24 of insulating material, either a separating device is used, or the carrier belt 26 and/or the pressing belt 27 has separating elements. In the illustrated embodiment, the wood chips and the binding agent are oppositely charged electrically in order to cause the application or impacting, respectively, to ensure a mixing, which is quick and as complete as possible.

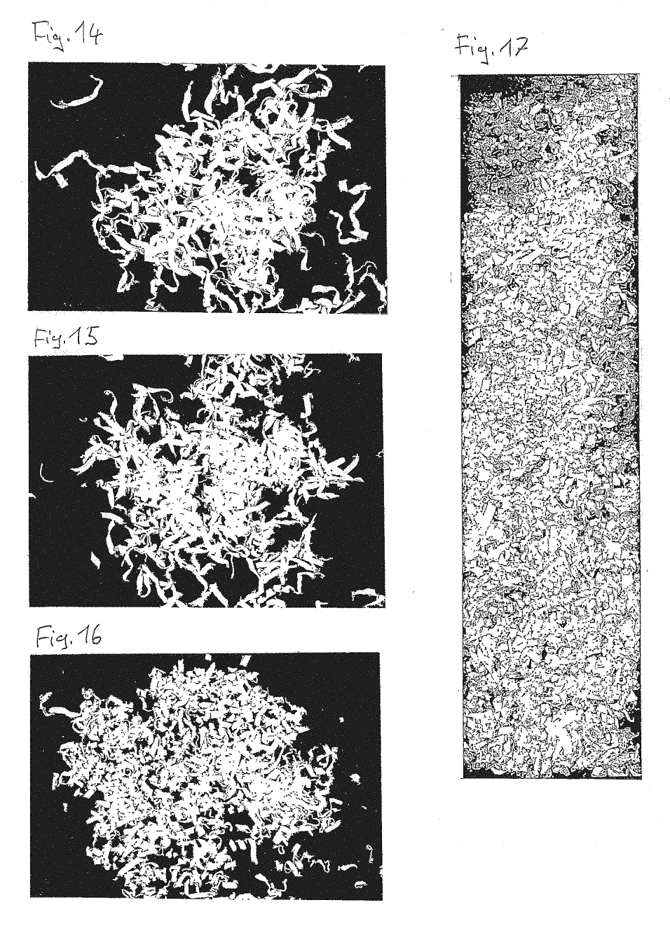

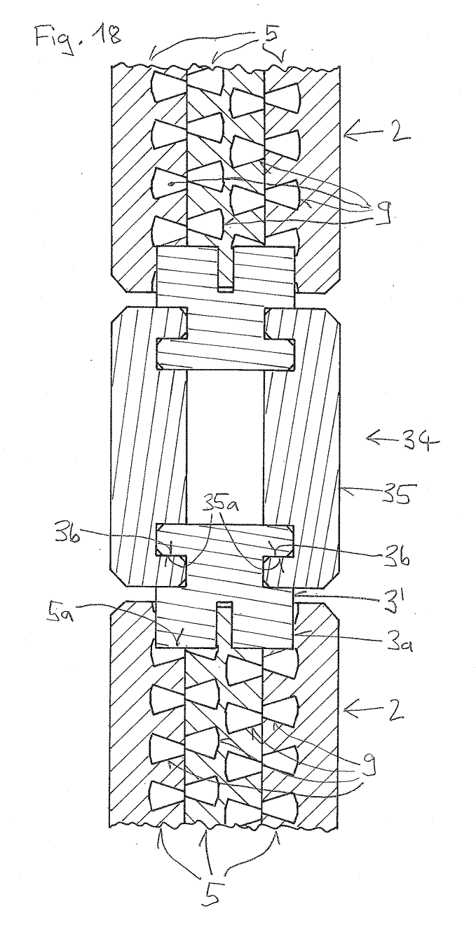

FIGS. 14, 15 and 16 show wood chips, which were manufactured by means of circular saw blades having a different diameter, wherein the diameter of the circular saw blade was 160 mm in the case of the chips of FIG. 14, 140 mm in the case of FIG. 15, and 120 mm in the case of FIG. 16. The longest chips of FIG. 14 have a length of just under 30 mm, in FIG. 15 just under 22 mm and in FIG. 16 just under 15 mm. It can be seen clearly that the maximum of the distribution of the chip lengths of FIG. 14 via FIG. 15 to FIG. 16 shifts gradually to smaller chip lengths. If all of the grooves of a board are manufactured with circular saw blades of different sizes, a chip mixture results from all of the grooves together, the chip length distribution of which is wider than in the case of the manufacture of chips by means of circular saw blades, which are all the same. A chip mixture comprising chip lengths, which are distributed across a desired length range, can ensure a more complex cavity structure, than chips, which all have substantially the same length.

FIG. 17 shows a section of a mat-shaped insulating material, which comprises wood chips, which were manufactured by means of circular saw blades comprising different diameters. A complex cavity structure, from which moisture can escape quickly, is formed in the insulating material. If the insulating material according to the invention is used in lightweight construction elements of houses, constantly moist areas do not form and biological decomposition processes can thus substantially be minimized.

In addition to the walls according to FIGS. 1, 2 and 2a, which are constructed with lightweight construction elements including insulating material, walls can also be constructed with lightweight panels 2. Walls with insulating material are specifically suitable to be used as outside walls. Interior building walls, which do not require an insulating material layer, can be built with lightweight panels 2. FIG. 18 shows an interior wall, which comprises lightweight panels 2, which are connected to one another, wherein the lightweight panels 2 preferably comprise at least three layers 5. Grooves 9 are formed on both sides in at least one middle layer 5, and are only formed on the side, which faces the at least one middle layer 5, in the two outer layers 5.

At both of the lightweight panels 2, which are to be connected, the illustrated connecting device 34 comprises frame parts 3′, which engage with second groove tongue arrangements 5a of the lightweight panels 2 by means of the first groove tongue arrangements 3a, wherein these engaging groove tongue arrangements 3a, 5a are glued to one another. So that the lightweight panels 5 can also be connected to one another easily at a construction site, the frame parts 3 have the connecting grooves 3b. Connecting strips 35 comprising groove tongue arrangements 35a make it possible to fixedly connect the frame parts 3 of the lightweight panels 2, which face one another, by using adhesives and/or connecting elements. If necessary, a cavity, which can be used for guiding of wirings, is created between the connecting strips 35 inserted from both sides.

It goes without saying that such interior walls can be covered or coated on one side or also on both sides. If necessary, a covering is held at a desired distance to the lightweight panels by spacers, so that a cavity, which can be used for installation purposes or for accommodating sound insulating material, for example, results between the lightweight panels and the covering.

1. A lightweight construction element comprising at least one lightweight panel and a layer of insulating material associated with the lightweight panel, wherein the at least one lightweight panel comprises boards, which, on at least one of the main surfaces thereof, have a group of grooves, which run parallel, and which boards are arranged in at least one layer and are connected to one another via adhesive bonds, wherein the layer of insulating material comprises wood chips, which are removed from starting boards during the manufacture of boards comprising grooves for the lightweight panel.

2. The lightweight construction element according to claim 1, wherein, at least a part of the grooves of the boards of the at least one lightweight panel have a groove width increasing away from the main surface towards the interior of the board and the webs of wood formed between these grooves accordingly becoming wider from the interior of the board towards the main surface and having a wide web surface on the main surface.

3. The lightweight construction element according to claim 1, wherein the at least one lightweight panel comprises at least two layers, and each layer is formed by boards comprising grooves, wherein the boards of each layer are connected to one another on the side edges thereof and the directly adjoining layers are connected on the main surfaces of the boards thereof via adhesive bonds, and grooves, which face one another, of different layers, which are connected to one another, run at an angle to one another.

4. The lightweight construction element according to claim 1, wherein, in at least a part of the layers the boards have on both main surfaces a group of grooves, which run parallel, and preferably a second group of parallel grooves at an acute angle to the first group grooves of this main surface.

5. The lightweight construction element according to claim 1, wherein the wood chips of the insulating material are substantially embodied in a strip-shaped and flat, corrugated, roll-shaped, spring-shaped or spiraled manner, and at least 80 percent by weight of the wood chips of the insulting material are formed by wood chips of a length in the range of between 2 mm and 40 mm.

6. The lightweight construction element according to claim 1, wherein the wood chips of the insulating material, together with a binding agent, form a substantially cohesive structure, the binding agent, comprises at least a portion of an organic binder and/or of an inorganic binder, wherein preferably the binder comprises tannin, preferably the organic binder comprises a polymer binder, preferably polyvinyl acetate (PVAc), and preferably the inorganic binder is an alkali polysilicate-based binder, preferably a mixture of sodium silicate and/or potassium silicate comprising lithium silicate.

7. A method for manufacturing a lightweight construction element comprising at least one lightweight panel and a layer of insulating material associated with the lightweight panel, wherein the at least one lightweight panel comprises boards, which, on at least one of the main surfaces thereof, have a group of parallel grooves and which are arranged in at least one layer and are connected to one another via adhesive bonds, wherein wood chips are removed from starting boards and are at least partially used to manufacture the layer of insulating material, where the boards with grooves are joined to form at least one layer of the lightweight panel.

8. The method according to claim 7, wherein at least one cavity, into which the wood chips are filled preferably together with a binding agent for manufacturing the layer of insulating material, is formed on the lightweight construction element between the at least one lightweight panel and at least one further panel, wherein the wood chips and the binding agent are preferably in each case oppositely charged electrically during the filling of the cavity, so that a mixing, which is as complete as possible, is ensured thereby.

9. The method according to claim 7, wherein wood chips are applied in a layered manner via at least one application device to a carrier belt so as to manufacture the layer of insulating material, a binding agent is applied to the wood chips (19) via a nozzle arrangement, and a pressing belt presses the wood chips, which are provided with the binding agent, against the carrier belt on a hardening path, wherein the carrier belt and/or the pressing belt preferably has separating elements for separating sections of the layer of insulating material, and preferably the wood chips and the binding agent are oppositely charged electrically for application or impacting, respectively, so that a mixing, which is as complete as possible, is ensured thereby.

10. The method according to claim 7, wherein, based on 1 m³ of wood in the form of raw boards of a weight of substantially 450 kg, 30 to 60 percent by weight, preferably substantially 180 kg of this wood material ends up in lightweight panels, the cavity portion of which is preferably in a range of between 30% and 50%, and that between 100 kg and 270 kg, preferably substantially 200 kg, of the removed residual material is used for the production of insulating material, wherein the density of the insulating material is in the range of between 60 and 90 kg/m³ and insulating material with a volume in the range of between 1.5 m³ and 3.5 m³ is preferably provided in the lightweight construction panels in addition to the wood material.

11. A lightweight panel comprising boards or comprising sections of boards, which boards or sections, respectively, have a group of grooves, which run parallel on at least one of the main surfaces thereof and are arranged in at least one layer and are connected to one another, wherein, at least a part of the grooves of the boards or sections, respectively, of the at least one lightweight panel, have a groove width increasing away from the main surface towards the interior of the board or section, respectively, and the webs of wood formed between these grooves accordingly becoming wider from the interior of the board or section, respectively, towards the main surface, and having a wide web surface on the main surface.

12. The lightweight panel according to claim 11, the lightweight panel comprising at least two layers and each layer is formed by boards comprising grooves, wherein the boards of each layer are connected to one another on the side edges thereof and the directly adjoining layers are connected on the main surfaces of the boards thereof via adhesive bonds, and grooves, which face one another, of different layers, which are connected to one another, run at an angle to one another.

13. The lightweight panel according to claim 11, wherein in at least a part of the layers the boards have a group of grooves running parallel on both main surfaces, and a second group of parallel grooves is preferably formed at least on one main surface at an acute angle to the first group of grooves of this main surface.

14. The lightweight panel according to claim 11, wherein cut short sections of the same length of lightweight panels, where the main surfaces of the boards run parallel to the outer surface of the lightweight panel, are rotated by 90°, are arranged next to one another in one layer and are brought into mutual connection with the partial surfaces of the outer surfaces of the divided lightweight panels, so that they form a layer of sections, wherein the cut surfaces of the connected sections form the outer surfaces of the layer of the short sections and a cover layer is preferably arranged on at least one of these outer surfaces.

15. (canceled)

16. An insulating material comprising wood particles and binding agent, wherein the wood particles are wood chips, which are removed from starting boards during the manufacture of boards (6) comprising grooves, wherein the wood chips are substantially embodied in a strip-shaped and flat, corrugated, roll-shaped, spring-shaped or spiraled manner, and at least 80 percent by weight of the wood chips of the insulting material are formed by wood chips of a length in the range of between 2 mm and 40 mm and the wood chips, together with the binding agent, form a substantially cohesive structure, the binding agent comprises at least one portion of an organic binder and/or of an inorganic binder, wherein the binder preferably comprises tannin, the organic binder preferably comprises a polymer binder, preferably polyvinyl acetate (PVAc), and the inorganic binder is preferably an alkali polysilicate-based binder, preferably a mixture of sodium silicate and/or potassium silicate comprising lithium silicate.
